(19) United States
(12) Patent Application Publication
(10) Pub. No.: US 2005/0025353 A1
(43) Pub. Date: Feb. 3, 2005

(54) Inspection apparatus and inspection method

(75) Inventors: Masaaki Kaneko, Tokyo (JP); Hitoshi Nakayama, Tokyo (JP); Hidetoshi Suzuki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/846,543

(22) Filed: May 17, 2004

(30) Foreign Application Priority Data
Jul. 29, 2003 (JP) 2003-281556

(51) Int. Cl. G06K 9/00

(52) U.S. Cl. 382/152

(57) ABSTRACT

An object of the present invention is to provide a method for picking up, upon mounting an electronic part, an image of a board for mounting, a mounted part and a fixing agent that contain a potion such as an adhesive that transmits light so as to inspect the mounting state. In order to achieve the object, in the method according to the present invention, a camera disposed just above the board for mounting, a first light source disposed diagonally above the board and a second light source disposed diagonally above the board but at a position different from the first light source are integrated as a unit and they are moved in a direction substantially parallel to the board for mounting to determine the position of the first light source etc. at which the light transmissive portion can be preferably photographed.

### BACKGROUND OF THE INVENTION

1. Field of the Invention

The present invention relates to an inspection method and an inspection apparatus for inspecting mounting state of a mounted part that has been mounted on a board for mounting by a part mounting apparatus. More specifically, the present invention relates to a method and an apparatus in which an image of a mounted part (which will be referred to as a work piece hereinafter) that has been fixed to a board for mounting by means of an adhesive or a solder paste is obtained and the mounting position or the mounting state thereof is detected based on the obtained image.

2. Related Background Art

In the apparatus for inspecting mounting state, a board for mounting or a board on which a work piece(s) has been mounted is illuminated with illumination light and the illuminated state is photographed by a camera, so that the mounting position etc. is detected based on shading in the obtained image. The image processing is generally performed by a value multiplexing process. However, if the difference in density (or light and shade) appearing on the board for mounting is small, the value multiplexing process sometimes takes a considerably long time.

Furthermore, in the case that the work piece has a complex contour, or in the case that the reflectance of the board for mounting, the reflectance of the adhesive and the reflectance of the work piece are close to each other and there are many undulations on their surfaces, it might be difficult to detect these shapes accurately based on the shade or the like obtained by simple illumination with light from one direction. Even when the shade or the like is obtained, if mixed undulations are present in a bright area and the difference in density is extremely small, there is the risk that the image processing cannot be carried out.

In order to address the above described difficulties, Japanese Patent Application Laid-Open No. 10-206237, for example, discloses a method in which a camera is disposed just above an object for which an outer appearance inspection is to be performed and the object is illuminated with illumination light from different directions so that satisfactory image processing will be carried out by comparing images obtained with respect to the respective directions with each other. According to a specific concept of this method, an image of an object to be inspected is obtained by casting light onto the object from a certain direction and then casting light to the object from a different direction to obtain an image in which a surface of the object that cannot be detected by the image obtained based on the light cast from said certain direction is made clear, so as to perform image processing preferably. In this method, reduction of the processing time is also intended by casting lights of different colors onto the object from different directions and color-separating an image captured by a single camera and then performing image processing.

Here, reference is made to Japanese Patent Application Laid-Open No. 05-288521 that discloses a method for measuring the thickness of an object in the form of a timber having substantially uniform reflectance, though the object of measurement is different. In that method, light is cast onto the object from one direction to obtain an image and then cast light from a different direction to obtain an image again, and the thickness is determined based on the shade or the like present in those images.

In a structure composed of a board for mounting, a solder paste and a work piece etc, which constitutes the object of inspection in the present invention, the wiring portion on the board for mounting and the solder paste are made of metals. These metal portions will totally reflect radiated light with respect to a specific direction in accordance their properties. Consequently, if a camera is disposed on the way of the direction in which the total reflection condition is met, an image in which only a specific portion has an extremely high brightness will be obtained, and it is very likely that the aforementioned appropriate image processing cannot be performed. In view of this, the light radiation position or the camera position should be set at a position that does not satisfy the total reflection condition.

On the other hand, in the case that the object to be inspected is composed of a board for mounting, an adhesive and a work piece etc, for example, an adhesive having the property of transmitting radiated light is sometimes used. In that case., under some illumination conditions, such as in the case that light is cast onto the adhesive portion from a direction in which light is easily and totally transmitted, it is not possible to make the adhesive itself clearly visible, but an image of a member existing under the adhesive (e.g. the board for mounting) is picked up. In view of this, the light radiation position or the camera position should be set at a position that does not satisfy this transmitting condition.

In the above-described structure disclosed in Japanese Patent Application Laid-Open No. 10-206237, it is considered that the aforementioned conditions in which appropriate images are difficult to obtain can be avoided by adjusting the position of a plurality of light sources or the radiation direction of light from the light sources. However, if the positional relationship between each light source and the camera is changed, the relationship between obtained images varies in accordance with the change in the aforementioned positional relationship, and therefore it is considered that simple comparison of the images can be inappropriate in some cases. After all, in the technology disclosed in this prior art document, the object to be inspected is chipping of a chip or the like, and it is inappropriate to apply this technology directly to inspection of a structure containing, for example, a solder paste, an adhesive or the like, for which, as described above, it is necessary to select the light illumination condition or other conditions as needed.

The invention disclosed in Japanese Patent Application Laid-Open No. 5-288521 is directed to measurement of the thickness of a timber made of a single material, and the technology disclosed in this document does not require the aforementioned changing of conditions such as the position of light sources. Therefore, it is inappropriate to apply the technology disclosed in this prior art document directly to inspection of a structure containing, for example, a solder paste, an adhesive or the like, for which, as described above, it is necessary to select the light illumination condition or other conditions as needed.

### SUMMARY OF THE INVENTION

The present invention has been made in view of the above described situation. An object of the present invention is to provide an inspection apparatus and an inspection method that are suitable for inspection of a structure that contains a solder paste or an adhesive, that is, suitable for inspection in which it is necessary to select the light illumination condition as needed. More specifically, the present invention relates to an apparatus and a method in which image processing is favorably performed by casting light onto an object to be inspected to obtain a shadow of an edge line of the object to be inspected and casting light from a different direction to determine whether or not the previously obtained shadow has been derived from the edge line. Furthermore, another object of the present invention is to provide an inspection apparatus and an inspection method that are suitable for an object to be inspected that contains a solder paste and an adhesive.

According to the present invention that is intended to achieve the above object, there is provided an inspection apparatus for inspecting a mounting state of a board for mounting, a mounted part mounted on the board for mounting and a fixing agent for fixing the mounted part on the board for mounting, comprising a camera for picking up an image of the board for mounting, the mounted part and the fixing agent from substantially directly above, a first light source for radiating light to the board for mounting, the mounted part and the fixing agent from diagonally above, and a second light source disposed at a position different from the first light source for radiating light to the board for mounting, the mounted part and the fixing agent from diagonally above, wherein the camera, the first light source and the second light source is integrated as a unit and the unit can move within a predetermined plane.

In the above-described inspection apparatus, it is preferable that the unit be constructed in such a way that the positional relationship between the first light source and the camera is fixed and the positional relationship between the second light source and the camera can be changed. In the above-described inspection apparatus, the unit may be constructed in such a way that the positional relationship between the first light source and the camera is fixed, the positional relationship between the second light source and the camera is fixed, and at least one of the radiation direction of light from the first light source and the radiation direction of light from the second light source can be changed. Furthermore, in the above-described inspection apparatus, it is preferable that the aforementioned predetermined plane be a plane parallel to the plane in which the-board for mounting extends and a movable area of the unit corresponds to an image pickup area of the camera. Incidentally, the fixed positional relationship mentioned in the above refers to a situation in which the positional relationship of the light source in which light radiation direction etc. can be adjusted and the camera is fixed and the light source and the camera is integrated.

According to another aspect of the present invention that is intended to achieve the aforementioned object, there is provided an inspection method for inspecting a mounting state of a board for mounting, a mounted part mounted on the board for mounting and a fixing agent for fixing the mounted part on the board for mounting, comprising a step of picking up an image of the board for mounting, the mounted part and the fixing agent by a camera disposed substantially directly above them while radiating light to the board for mounting, the mounted part and the fixing agent from a first light source disposed diagonally above them, and adjusting the position of the camera and the first light source within a predetermined plane under a state in which the positional relationship between the camera and the first light source is fixed, a step of storing an image obtained by the camera and the first light source under a disposition after the adjustment as a first image, a step of picking up an image of the board for mounting, the mounted part and the fixing agent by the camera while radiating light to the board for mounting, the mounted part and the fixing agent from a second light source disposed at a position different from the first light source in relation to the board for mounting, the mounted part and the fixing agent, and adjusting the position of the second light source, a step of picking up an image of the board for mounting, the mounted part and the fixing agent by the camera while irradiating the board for mounting, the mounted part and the fixing agent with light from the second light source after the position adjustment, and storing an obtained image as a second image, and a step of detecting a mounting state of the board for mounting, the mounted part and the fixing agent based on the first image and the second image.

In the above-described inspection method, it is preferable that the positional relationship of the second light source relative to the camera and the first light source be fixed and they be integrated as a unit. Furthermore, in the above described inspection method, it is preferable that the predetermined plane be a plane parallel to the plane in which the board for mounting extends and a movable area of the unit correspond to an image pickup area of the camera. Still further, in the above-described inspection method, the step of adjusting the position of the camera and the first light source within the predetermined plane may include a step of changing the radiation direction of light from the first light source. In addition, the step of adjusting the position of the second light source may include a step of changing the radiation direction of light from the second light source.

According to still other aspect of the present invention that is intended to achieve the aforementioned object, there is provided an inspection method for inspecting a mounting state of a board for mounting, a mounted part mounted on the board for mounting and a fixing agent for fixing the mounted part on the board for mounting, comprising a step of picking up an image of the board for mounting, the mounted part and the fixing agent by a camera disposed substantially directly above them while radiating light to the board for mounting, the mounted part and the fixing agent from a first light source disposed diagonally above them, and adjusting the radiation direction of light from the first light source, a step of storing an image obtained by the camera and the first light source under a disposition after the adjustment as a first image, a step of picking up an image of the board for mounting, the mounted part and the fixing agent by the camera while radiating light to the board for mounting, the mounted part and the fixing agent from a second light source disposed at a position different from the first light source in relation to the board for mounting, the mounted part and the fixing agent, and adjusting the radiation direction of light from the second light source, a step of picking up an image of the board for mounting, the mounted part and the fixing agent by the camera while irradiating the board for mounting, the mounted part and the fixing agent with light from the second light source after the radiation direction adjustment, and storing an obtained image as a second image, and a step of detecting a mounting state of the board for mounting, the mounted part and the fixing agent based on the first image and the second image.

In the inspection apparatus and the inspection method according to the present invention, an image of a board for mounting, a mounted part and an adhesive agent is picked up by a camera disposed substantially directly above them while the board for mounting etc. are irradiated with light from the first light source from diagonally above. According to the present invention, in this process, the positional relationship between the first light source and the camera is fixed after it has been adjusted to an optimum state. As described before, when an image of the fixing agent such as a solder paste or an adhesive is to be obtained while it is irradiated with light, it is necessary to chose the position of the light source that emits light.

According to the present invention, the first light source and the camera is integrated, and therefore the positional relationship of the light source and the camera will not change even if the position of light source is finely adjusted. In addition, upon this fine adjustment, the first light source and the camera are moved in the direction parallel to the direction in which the board for mounting extends. Furthermore, the area of movement of the first light source and the camera upon the aforementioned fine adjustment is set in such a way that the board for mounting always stays within the image pickup area of the camera. Therefore, the size of the image of the board for mounting and the mounted part picked up by the camera does not vary for each board for mounting.

An image of the board for mounting etc. can be picked up at always the same size as long as the position of the first light source is adjusted in such a way that the above conditions are satisfied. Therefore, comparison, combination or other operations of images can be performed easily and the detection of the mounting state can be carried out easily. In other words, it is possible to perform inspection of each board for mounting etc. without changing a calculation parameter etc., and reduction of inspection time and enhancement of inspection accuracy can be expected.

The second light source may be integrated with the camera and the first light source to form a unit in a similar manner as the first light source. In that case, the unit is moved parallel to the plane in which the board for mounting extends and the movement range is set in such a way that the board for mounting etc. always stays within the image pickup area of the camera, as described before. With this feature, the size of an image of the board for mounting etc. obtained with the first light source and the size of an image of the board for mounting etc. obtained with the second light source becomes equal to each other and the aforementioned advantageous effects are realized.

The first and second light sources may be adapted to be rotatable about a rotation axis that is perpendicular to their own optical axis. When the light source is rotated, the illumination condition of the radiated light for the board for mounting etc. is changed, so that the allowable range of the light source position can be extended. In addition, in order to pick up an image of the board for mounting etc. at a size smaller than a predetermined size within the image pickup area of the camera irrespective of the type of the board for mounting etc., it is preferable that camera be adapted to be movable in the direction perpendicular to the plane in which the board for mounting extends. In addition, in order to obtain a clear image, it is preferable that upon picking up an image of the board for mounting etc., the board be positioned at a point at which the optical axes of the first light source, the second light source and the camera intersect. Therefore, it is preferable that the first light source and the second light source be adapted in such a way that they can be rotated synchronously in accordance with the aforementioned movement of the camera in the perpendicular direction.

The unit may be constructed in such a way that only the second light source can be moved within the unit. In that case, the position of the second light source is changed while the position of the camera and the first light source is fixed, after an image of the board for mounting etc. is obtained under the state in which the image pickup condition with the camera and the first light source has been determined. With such a structure, an image of the same size of the board for mounting etc. can be obtained with the second light source while enlarging the adjustment range of the position of the second light source. Alternatively, at least one of the first and second light sources may be adapted to be rotatable so that the illumination condition can be further optimized by adjusting the light radiation direction by means of rotation of the light source.

As per the above, according to the present invention, even in the case that an image of an object including a part that requires adjustment of the position of a light source that radiates light, such as a solder paste or a transparent adhesive or the like, is to be picked up, a satisfactory image can be picked up while adjusting the position of the light source. Therefore, the contour of the mounted part or the edge of the fixing agent can be detected easily and the mounting state can be detected easily and accurately.

### BRIEF DESCRIPTION OF THE DRAWINGS

FIG. 1 is a perspective view schematically showing a principal part of an inspection apparatus according to an embodiment of the present invention.

FIG. 2 schematically shows the disposition of the inspection apparatus and a board for mounting etc. under a state in which the mounting state of the board for mounting etc. is inspected by the inspection apparatus shown in FIG. 1.

FIG. 3A shows a state in which the board for mounting etc. is photographed by the camera shown in FIG. 1.

FIG. 3B shows a state in which the board for mounting etc. is photographed by the camera shown in FIG. 1.

FIG. 4 is a perspective view showing a modification of the embodiment shown in FIG. 1.

### DESCRIPTION OF THE PREFERRED EMBODIMENTS

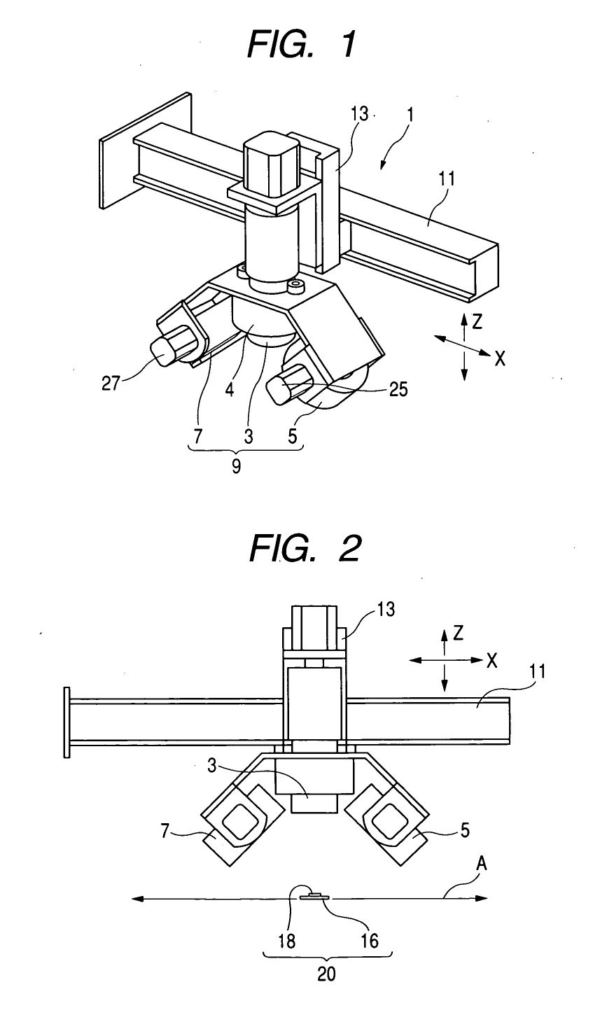

FIG. 1 is a perspective view showing an inspection apparatus according to an embodiment of the present invention, where the principal portion of the apparatus including a camera and first and second light sources are shown. The principal portion 1 of the inspection apparatus according to the present invention includes a unit 9 composed of a camera 3 directed vertically downwardly, an illumination light source 4 disposed coaxially with the camera 3, used for detection of a board and first and second light sources 5 and 7 disposed on both sides of the camera 3. The first and second light sources 5 and 7 are oriented toward a position below and on the axis of the camera 3. The unit 9 is supported by a first support rail 11 and a second support rail 13 in such a way that the unit 9 can be driven in the direction indicated by X and Z in FIG. 1. Various well-known mechanisms may be used as a driving mechanism for actually driving the unit 9 in the X and Z directions. The description of that mechanism will be omitted in this specification, since the mechanism per se is not directly relevant to the present invention.

The first light source 5 and the second light source 7 are mounted on the camera 3 by means of a first rotating mechanism 25 and a second rotating mechanism 27 respectively so that the first and second light source can be rotated about respective rotation axes that are perpendicular to the respective optical axes. A favorable light illumination direction will be realized by rotating the light sources using these rotation mechanisms so as to adjust the optical axis of the light sources. As the unit 9 is adapted to be driven in the Z direction by the second support rail 13, it is possible to pickup an image of a board for mounting or the like at a predetermined size in the finder of the camera 3 regardless of the size and type of the board for mounting.

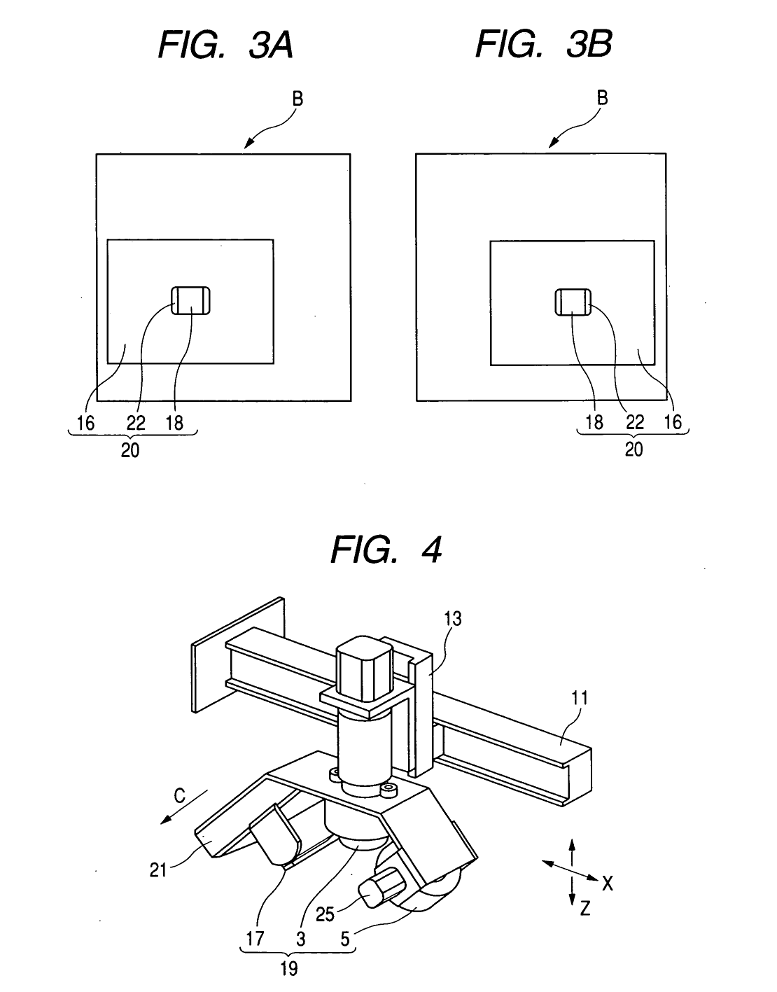

FIG. 2 shows an arrangement with which the mounting state of a work piece fixed on a board for mounting is detected by means of the principal portion 1. FIG. 2 schematically shows the board for mounting and the principal portion 1 as seen from the front side. An object to be photographed 20 comprises a board for mounting 16, a work piece 18 and a fixing agent (designated by reference numeral 22 in FIGS. 3A and 3B, but not shown in FIG. 2). The object to be photographed 20 is positioned in the vicinity of the point at which the optical axis of the camera 3, the optical axis of the first light source 5 and the optical axis of the second light source 7 intersect. The plane A on which the board for mounting 16 extends is substantially parallel with the aforementioned X axis. In this arrangement, light is radiated from the first light source 5 toward the object to be photographed 20 and an image of the object to be photographed 20 as illuminated in this way is picked up by the camera 3.

FIGS. 3A and 3B schematically show images picked up by the camera 3 under the above-described arrangement. In the present invention, the image pickup area (the finder of the camera 3) B is designed to be sufficiently larger than the object to be photographed 20 illuminated by the light radiated from the first light source 5. In the actual image pickup process, an image of the object to be photographed 20 is picked up firstly under the state shown in FIG. 3A. At that time, whether at least several parts of the fixing agent 22 and the boundary or contour can be favorably photographed is checked based on the image. If a favorable image cannot be obtained due to reflection at the fixing agent or other reasons, the unit 9 is moved along the X direction so that a position at which an favorable image can be obtained is determined.

The shift amount of the unit 9 along the X direction is limited by the image pickup area B, and so the images shown in FIGS. 3A and 3B are the images obtained when the unit 9 is positioned at the right limit and the left limit of its movable area. When the driving direction of the unit 9 is set to the X direction and the driving area is made to be correspond to the image pickup area of the camera 3, the size of the object to be photographed 20 in the obtained image is always constant.

Subsequently, a next image is picked up with light radiated from the second light source 7. In this case also, the operation same as the above-described image pickup operation performed with the first light source 5 is carried out and a position at which at least several of the fixing agent 22 and the boundary can be favorably photographed is determined. By setting the conditions for the driving direction and the driving area of the unit 9 in the same manner as in the case with the first light source 5, the size of the object to be photographed in the obtained image becomes equal to that in the case with the first light source 5. Therefore, comparison and combination of two images obtained with the first and second light sources can be easily performed, and therefore the mounting state can be detected easily and quickly.

In this embodiment, the first light source 5 and the camera etc. are driven in the X direction to optimize the illumination condition. However, the apparatus may be modified in such a way that the optimum photographing condition may be determined by positioning the first light source 5 and the camera at a position just above the object to be photographed and then adjusting the light radiation angle from the first light source 5 by means of the first rotation mechanism 25. With respect to the second light source 7 also, the light radiation angle from the second light source 7 may be adjusted by means of the second rotation mechanism to determine the optimum photographing condition.

A modification of the apparatus of this embodiment shown in FIG. 4 is also preferable. What is different in the inspection apparatus shown in FIG. 4 from the inspection apparatus shown in FIG. 1 is only the second light source. Therefore, only the second light source will be described in the following. In this modification, the second light source 17 is supported by the third support rail 21 in such a way that it can be driven in a predetermined direction indicated by arrow C. The second light source 17 is driven in the direction C by means of a well-known driving mechanism. Since the driving mechanism is not directly relevant the present invention, the description thereof will be omitted. In addition, the first light source may also be supported by the structure same as that for the second light source in order to enlarge the position adjustment range of the light source.

In this modification, in the case that a satisfactory image of the object to be photographed is obtained under the state shown in FIG. 3A by the first light source and the camera 3, the position of the camera 3 (and the first light source 5) is not changed in the subsequent photographing operation that is performed using the second light source. Under this state, only the second light source 17 is driven in the direction C so as to determine the position of the second light source 17 at which the fixing agent 22 and its boundary can be favorably photographed. After the preferable position is determined, the second light source 17 is fixed, and image pickup by the camera 3 and storing of the picked up image are carried out. After that, the positional relationship of the board for mounting, the mounted part and the fixing agent is determined based on comparison, combination and other operations on the two obtained images. Thus, the mounting state is detected.

According to this structure, not only the size but also the image pickup position of the image obtained using the first light source 5 coincide with those of the image obtained by using the second light source 17. Therefore, operations such as comparison and combination of the images can be performed more easily and inspection can be carried out more quickly.

Although two light sources are used in the above-described embodiments, the present invention is not limited to this particular feature, but more than two light sources may be used. In the case that more than two light sources are used, instead of driving the aforementioned first or second light source, other light sources included in the apparatus may be selectively used to obtain images used for comparison and combination. Furthermore, although in the above embodiments the camera and other parts are driven only in the X direction, the apparatus may be modified in such a way that they are driven in the Y direction also so that they can be driven on a plane parallel to the board for mounting. In the foregoing, the object to be photographed 20 composed of the board for mounting 16, the work piece 18 and the fixing agent 22 has been described by way of example. However, the present invention is not limited to that example, but an object to be photographed 20 may be composed of only a work piece 18 and a fixing agent 22.

1. An apparatus for inspecting a mounting state of a board for mounting, a mounted part mounted on said board for mounting and a fixing agent for fixing said mounted part on said board for mounting, comprising:
a camera for picking up an image of said board for mounting, said mounted part and said fixing agent from substantially directly above;
a first light source for radiating light to said board for mounting, said mounted part and said fixing agent from diagonally above; and
a second light source disposed at a position different from the said first light source for radiating light to said board for mounting, said mounted part and said fixing agent from diagonally above,
wherein said camera, said first light source and said second light source is integrated as a unit and said unit can move within a predetermined plane.

2. An apparatus according to claim 1, wherein said unit is constructed in such a way that the positional relationship between said first light source and said camera is fixed and the positional relationship between said second light source and said camera can be changed.

3. An apparatus according to claim 1, wherein said unit is constructed in such a way that the positional relationship between said first light source and said camera is fixed, the positional relationship between said second light source and said camera is fixed, and at least one of the radiation direction of light from said first light source and the radiation direction of light from said second light source can be changed.

4. An apparatus according to claim 1, wherein said predetermined plane is a plane parallel to the plane in which said board for mounting extends and a movable area of said unit corresponds to an image pickup area of said camera.

5. A method for inspecting a mounting state of a board for mounting, a mounted part mounted on said board for mounting and a fixing agent for fixing said mounted part on said board for mounting, comprising the steps of:
picking up an image of said board for mounting, said mounted part and said fixing agent by a camera disposed substantially directly above them while radiating light to said board for mounting, said mounted part and said fixing agent from a first light source disposed diagonally above them, and adjusting the position of said camera and said first light source within a predetermined plane under a state in which the positional relationship between said camera and said first light source is fixed;
storing an image obtained by said camera and said first light source under a disposition after said adjustment as a first image;
picking up an image of said board for mounting, said mounted part and said fixing agent by said camera while radiating light to said board for mounting, said mounted part and said fixing agent from a second light source disposed at a position different from said first light source in relation to said board for mounting, said mounted part and said fixing agent, and adjusting the position of said second light source;
picking up an image of said board for mounting, said mounted part and said fixing agent by said camera while irradiating said board for mounting, said mounted part and said fixing agent with light from said second light source after the position adjustment, and storing an obtained image as a second image; and
detecting a mounting state of said board for mounting, said mounted part and said fixing agent based on said first image and said second image.

6. A method according to claim 5, wherein the positional relationship of said second light source relative to said camera and said first light source is fixed and said second light source and they are integrated as a unit.

7. A method according to claim 5, wherein said predetermined plane is a plane parallel to the plane in which said board for mounting extends and a movable area of said unit corresponds to an image pickup area of said camera.

8. A method according to claim 5, wherein said step of adjusting the position of said camera and said first light source within the predetermined plane includes a step of changing the radiation direction of light from said first light source.

9. A method according to claim 5, wherein said step of adjusting the position of said second light source includes a step of changing the radiation direction of light from said second light source.

10. A method for inspecting a mounting state of a board for mounting, a mounted part mounted on said board for mounting and a fixing agent for fixing said mounted part on said board for mounting, comprising the steps of:
picking up an image of said board for mounting, said mounted part and said fixing agent by a camera disposed substantially directly above them while radiating light to said board for mounting, said mounted part and said fixing agent from a first light source disposed diagonally above them, and adjusting the radiation direction of light from said first light source;
storing an image obtained by said camera and said first light source under a disposition after said adjustment as a first image;
picking up an image of said board for mounting, said mounted part and said fixing agent by said camera while radiating light to said board for mounting, said mounted part and said fixing agent from a second light source disposed at a position different from said first light source in relation to said board for mounting, said mounted part and said fixing agent, and adjusting the radiation direction of light from said second light source;
picking up an image of said board for mounting, said mounted part and said fixing agent by said camera while irradiating said board for mounting, said mounted part and said fixing agent with light from said second light source after the radiation direction adjustment, and storing an obtained image as a second image; and
detecting a mounting state of said board for mounting, said mounted part and said fixing agent based on said first image and said second image.
